(19) United States
(12) Patent Application Publication
(10) Pub. No.: US 2008/0113247 A1
(43) Pub. Date: May 15, 2008

(54) CATHODE FUEL FLOW BOARD FOR FUEL CELL

(76) Inventors: HSI-MING SHU, Taipei (TW); Tsang-ming Chang, Taipei (TW); Chih-Jung Kao, Taipei (TW); Yu-Chin Wang, Taipei (TW); Chun Wei Pan, Taipei (TW); Chia Hao Chang, Taipei (TW)

Correspondence Address: G. LINK CO., LTD., 3550 BELL ROAD, MINOOKA, IL, 60447, US

(21) Appl. No.: 11/938,300

(22) Filed: Nov. 12, 2007

(30) Foreign Application Priority Data
Nov. 13, 2006 (TW) 095219950

(51) Int. Cl. H01M 2/00

(52) U.S. Cl. 429/34

(57) ABSTRACT

The present invention discloses a cathode fuel flow board for fuel cell, which comprises: a substrate, at least one main channel, and at least one sub channel. The main channels are arranged on the substrate. The sub channels are arranged on the substrate, and the sub channels are intersected and connected with the main channels; wherein, the size of the sub channel is smaller than the size of the main channel. Moreover, the structure of the sub channel may be a groove structure, or a hollow area by digging a small portion of the area of the substrate, and may also be a groove body structure.

### FIELD OF THE INVENTION

The present invention relates to a fuel flow board for fuel cell, and particularly to a cathode fuel flow board, which provides a flow field environment with smooth flow for cathode reactant and cathode product.

### BACKGROUND OF THE INVENTION

The fuel cell is a generation device, which directly converts the chemical energy stored in the fuel and oxidant through electrode reaction into electricity. Nowadays, there are numerous types of fuel cells, which could be categorized by the difference of electrolyte characteristics. There are five types of fuel cells with different electrolytes, such as alkaline fuel cell, phosphorous acid fuel cell, proton exchange membrane fuel cell, molten carbonate fuel cell, solid oxide fuel cell. Although recently the fuel cell technology has gained some progresses, it still face a great challenge on commercialization, which involves with different levels of problems, such as low power density, water management, heat management, miniaturization, and high cost.

Most of the fuel cells will generate water product after electrochemical reaction. The treatment for water product in the fuel cell system design is always an extremely important issue. How to handle the liquid water generated by the fuel cell, or how it could be recycled, and the like, are all the problems needed to be fully solved, then the fuel cell could have the possibility of commercialization.

Especially, the flooding effect is frequently happening in the process of electrochemical reaction in the fuel cell, which is a serious problem extremely needed to be solve. There are numerous factors causing the flooding, which are possibly related to the current environmental conditions, such as temperature, or flow field conditions (natural convection and forced convection), and also possibly directly from the liquid water generated by the electrochemical reaction in the fuel cell. However, the liquid water might possibly accumulated in the gas channel of the cathode fuel flow board, and block the air channel, which would cause the reactant, such as air or oxygen, for the cathode of the fuel cell not being able to introduce, and the cathode product, i.e. water or vapor, could not be effectively exhausted, so that the performance of the fuel cell would be deteriorated. Moreover, the liquid water might possibly be leaked to the circuit of the electronic product due to insufficient management of the conventional fuel cell system, and causing the failure or short circuit in the electronic product.

### SUMMARY OF THE INVENTION

The main object of the present invention is to provide a cathode fuel flow board for solving the flooding effect, and also to provide a flow field environment with smooth flow for cathode reactant and cathode product.

In order to achieve the object according to the present invention, the present invention provides a cathode fuel flow board for fuel cell, which comprises: a substrate; at least one main channel, which are arranged on the substrate; and, at least one sub channel, which are arranged on the substrate, and the sub channels are intersected and connected with the main channels, in which the size of the sub channel is smaller than the size of the main channel, and the structure of the sub channel may be a groove structure, or a hollow area by digging a small portion of the area of the substrate, and may also be a groove body structure, in which the groove body structure is configured in the main channels.

### BRIEF DESCRIPTION OF THE DRAWINGS

The present invention would be detailed described in the following to make the skilled in the art further understand the objects, features, and effects of the present invention with the embodiments and the attached figures wherein:

FIG. 1A is a three-dimensional diagram for a first embodiment of a cathode fuel flow board for fuel cell according to the present invention;

FIG. 1B is a top view for the cathode fuel flow board in FIG. 1A;

FIG. 2A is a three-dimensional diagram for a second embodiment of a cathode fuel flow board for fuel cell according to the present invention;

FIG. 2B is a top view for the cathode fuel flow board in FIG. 2A; and

FIG. 3 is a partial cross-sectional view for a third embodiment of a cathode fuel flow board for fuel cell according to the present invention.

### DETAILED DESCRIPTION OF THE INVENTION

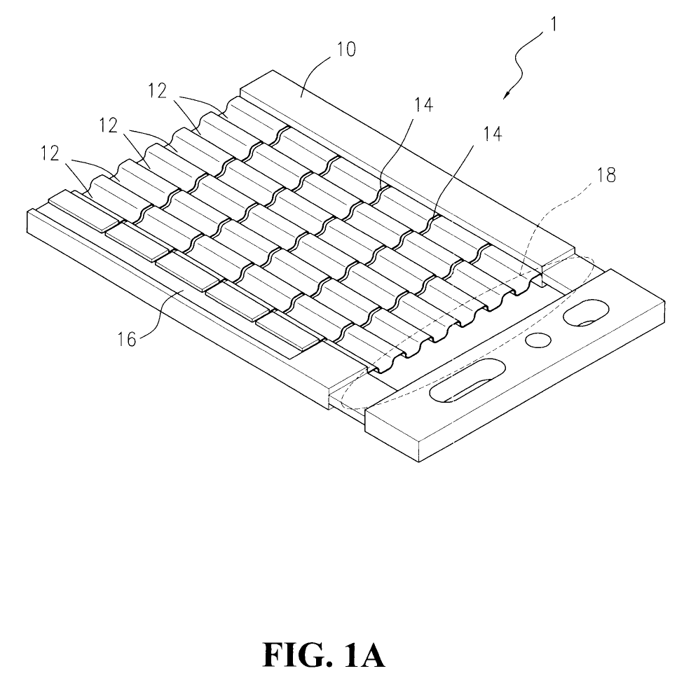

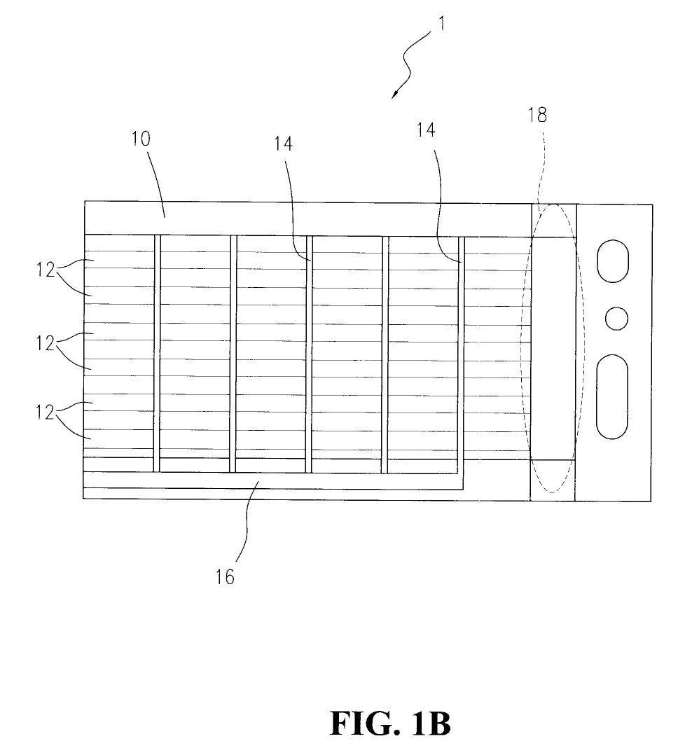

FIG. 1A is a three-dimensional diagram for a first embodiment of a cathode fuel flow board for fuel cell according to the present invention. FIG. 1B is a top view for the cathode fuel flow board in FIG. 1A. The cathode fuel flow board 1 according to the present invention is applied in a fuel cell, in which the fuel cell is provided with at least one membrane electrode assembly. The cathode fuel flow board 1 is used to supply air or oxygen to the cathode of the membrane electrode assembly for electrochemical reaction. Referring to FIG. 1A, the cathode fuel flow board 1 according to the present invention comprises: a substrate 10, at least one main channel 12, and at least one sub channel 14, which are described in details as follows.

The substrate 10 could be selected one from an anti-chemical non-conductive engineering plastic substrate, a graphite substrate, a metal substrate, a plastic carbon substrate, a FR4 substrate, a FR5 substrate, an epoxy resin substrate, a glass fiber substrate, a ceramic substrate, a polymer plasticized substrate, and a composite material substrate. If the main channels 12 and the sub channels 14 are configured on the upper surface of the substrate 10, it will be formed as a single-face cathode fuel flow board 1. On the other hand, if the main channels 12 and the sub channels 14 are configured on both the upper surface and the lower surface of the substrate 10, it will be formed as a double-face cathode fuel flow board 1.

The main channels 12 are arranged on the substrate 10, and play as the flowing channel for air or oxygen. As shown in FIG. 1A and FIG. 1B, the main channels 12 are parallel, and arranged on the substrate 10 with intervals. The air or oxygen flowing in the main channels 12 could be exhausted to the atmosphere, or introduced to a condensing device (not shown).

The sub channels 14 are arranged on the substrate (10), and the sub channels 14 are intersected and connected with the main channels 12, in which the size of the sub channel 14, especially the width of the channel, is smaller than the size of the main channel 12. As shown in FIG. 1A and FIG. 1B, the sub channels 14 are parallel and arranged on the substrate 10 with intervals, and the sub channels 14 are vertically intersected with the main channels 12. Although the sub channels 14 in FIG. 1A and FIG. 1B are vertically intersected with the main channels (12), the cathode fuel flow board 1 according to the present invention is not limited to this embodiment aspect, and certainly could be applied with other changes, such as the sub channels 14 could be intersected with the main channels 12 in a slanted manner. Moreover, one of the means for implementing the sub channels 14 is to dig downwardly from the surface of the substrate 10 with a plurality of parallel grooves. Another means for implementing the sub channels 14 is to dig a small portion (strips) of the area of the substrate 10 as a hollow area. Finally, the shape for the groove or the hollow area could be the pattern presented as the sub channels 14 in FIG. 1B.

Furthermore, the present invention further comprises a water collection tank 16 and an inlet channel structure 18. The water collection tank 16 is configured on the substrate 10, and connected with the sub channels 1 for collecting the liquid water flowing downwardly along the sub channels 14. The means for implementing the water collection tank 16 is to dig downwardly from the surface of the substrate 10 with a rectangular tank, but not being hollow. Another means for implementing the water collection tank 16 is suitable for the structure of fuel cell stack, in which the water collection tank 16 is similarly dug from the surface of the substrate 10 as a rectangular tank, but being hollow. In the fuel cell stack, one side of the water collection tank 16 is covered by the edge pallet or the partition pallet, so as to form a tank structure accommodating the liquid water. As shown in FIG. 1A, the water collection tank 16 is also penetrated through one side of the substrate 10, so as to pump the collected liquid water from the water collection tank 16 for recycling usage.

The inlet channel structure 18 is configured on the substrate 10, and connected with the main channels 12. The inlet area of the inlet channel structure 18 is to dig from the surface of the substrate 10 as a recess structure, and the area of the inlet channel structure 18 connected with the main channels 12 employs a hollow structure, that is to dig out the surface of the substrate 10 occupied by the adjacent area.

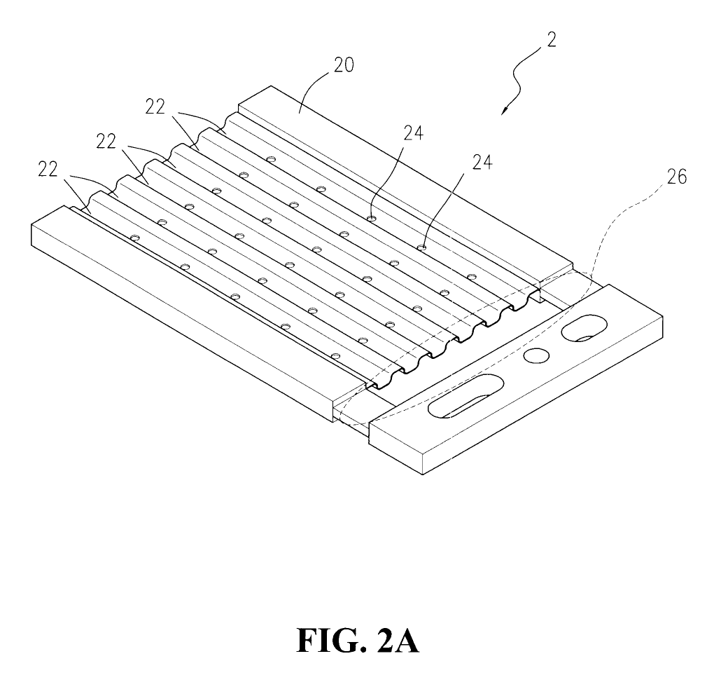

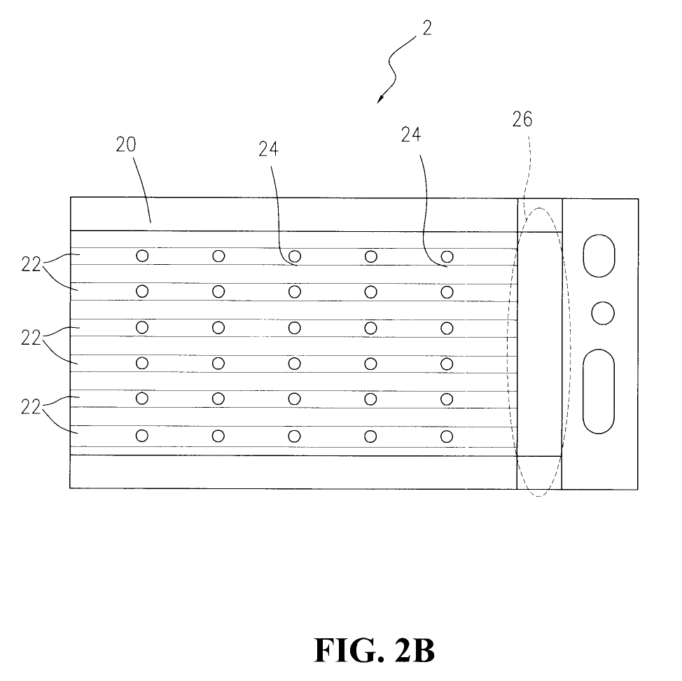

FIG. 2A is a three-dimensional diagram for a second embodiment of a cathode fuel flow board for fuel cell according to the present invention. FIG. 2B is a top view for the cathode fuel flow board in FIG. 2A. By comparing the FIG. 2A and FIG. 1A, it could be noted that the main difference between the two embodiments is that the structure of the sub channel 24 is different from the structure of the sub channel 14. As shown in FIG. 2A and FIG. 2B, the sub channel (24) employs a circular tank structure, and the tank structure is configured in the main channel 22. It could be known from the figure that the size of the sub channel 24 is obviously smaller than the size of the main channel 22. Moreover, the sub channel 24 may also be a hollow area by digging a small portion (circular) of the area of the substrate (20).

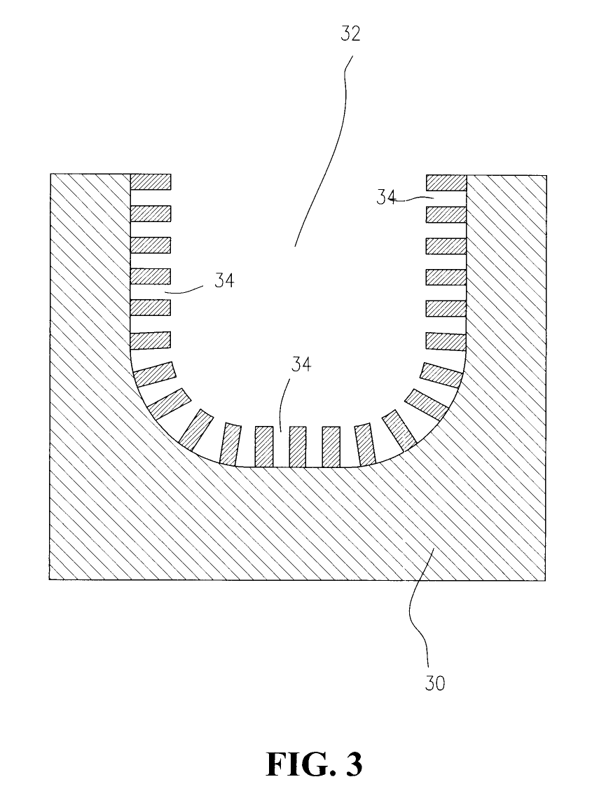

FIG. 3 is a partial cross-sectional view for a third embodiment of a cathode fuel flow board for fuel cell according to the present invention. Referring to FIG. 3, the cathode fuel flow board according to the present invention comprises a substrate 30, at least one main channel 32, and a plurality of sub channels 34. As shown in FIG. 3, the sub channel 34 is a groove structure, and the groove structure is configured on the surface of the main channel 32. Finally, the sub channels 34 are formed as a zigzag structure on the surface of the corresponding main channel 32.

The cathode fuel flow board according to the present invention could be applied to all kinds of fuel cells, such as the fuel cell employing methanol fuel, or the fuel cell employing liquid fuel, the fuel cell employing gas fuel, and the fuel cell employing solid fuel.

The cathode fuel flow board according to the present invention is characterized in the configuration of the sub channel. With the configuration of the sub channels and the intersection with the main channels, no matter the embodiment in FIG. 1A for vertically intersection of the sub channels with the main channels, or the embodiment in FIG. 2A and FIG. 3 for configuring the sub channels in the main channels, a portion of liquid water generated by the fuel cell will all flow into the sub channels. The object is to disperse the liquid water as far as possible without condensing together. Thus, the liquid water could be more easily converted into vapor, and flow out together with the air in the main channels. Besides, the liquid water would be blown by the air in the main channels to be gradually blown to dry. Therefore, the cathode fuel flow board according to the present invention could effectively solve the flooding problem at the cathode of the fuel cell, and also provide a flow field environment with smooth flow for cathode reactant and cathode product, which is the advantage, the benefit and the improvement effect provided by the present invention.

The present invention has been disclosed with embodiments as above. However, the disclosed embodiments are not used to limit the present invention. The skilled in the art could make various changes and modification without departing from the spirit and scope of the present invention, and the changes and modification made thereto are all belonging to the scope of the present invention. The protection scope for the present invention should be defined with the attached claims.

What is claimed is:

1. A cathode fuel flow board for fuel cell, which comprises:
a substrate;
at least one main channel, which are arranged on the substrate;
at least one sub channel, which are arranged on the substrate, and the sub channels are intersected and connected with the main channels, in which the size of the sub channel is smaller than the size of the main channel.

2. The cathode fuel flow board according to claim 1, wherein the sub channel is a groove structure.

3. The cathode fuel flow board according to claim 1, wherein the sub channel is a hollow area by digging a small portion of the area of the substrate.

4. The cathode fuel flow board according to claim 1, wherein the sub channel is a groove body structure, and the groove body structure is configured in the main channel.

5. The cathode fuel flow board according to claim 1, wherein a plurality of the sub channels is configured on the surface of the corresponding main channel, and each of the sub channels is a groove structure.

6. The cathode fuel flow board according to claim 1, further comprises: a water collection tank configured on the substrate, which is connected with the sub channel.

7. The cathode fuel flow board according to claim 1, further comprises: an inlet channel structure configured on the substrate, which is connected with the main channel, in which the inlet area of the inlet channel structure is a recess structure, and the area of the inlet channel structure adjacent to the main channel is a hollow structure.

8. The cathode fuel flow board according to claim 1, wherein the main channels are parallel, and arranged on the substrate with intervals.

9. The cathode fuel flow board according to claim 1, wherein the sub channels are parallel, and arranged on the substrate with intervals.

10. The cathode fuel flow board according to claim 9, wherein the sub channels are vertically intersected with the main channels.

11. The cathode fuel flow board according to claim 1, wherein the substrate is selected one from an anti-chemical non-conductive engineering plastic substrate, a graphite substrate, a metal substrate, a plastic carbon substrate, a FR4 substrate, a FR5 substrate, an epoxy resin substrate, a glass fiber substrate, a ceramic substrate, a polymer plasticized substrate, and a composite material substrate.

12. The cathode fuel flow board according to claim 1, wherein the cathode fuel flow board is a single-face cathode fuel flow board.

13. The cathode fuel flow board according to claim 1, wherein the cathode fuel flow board is a double-face cathode fuel flow board.
